(19) United States
(12) Patent Application Publication
(10) Pub. No.: US 2012/0164291 A1
(43) Pub. Date: Jun. 28, 2012

(54) SOFT CANDY AND SOFT CANDY PRODUCTION METHOD

(75) Inventors: Hiroyuki Kubo, Yokohama-shi (JP); Yoshie Kato, Yokohama-shi (JP)

(73) Assignee: MORINAGA & CO., LTD., Tokyo (JP)

(21) Appl. No.: 13/393,614

(22) PCT Filed: Sep. 3, 2010
(86) PCT No.: PCT/JP2010/065138

§ 371 Date: Mar. 1, 2012

(30) Foreign Application Priority Data
Sep. 16, 2009 (JP) 2009-214319

(51) Int. Cl. A23G 3/36; A23L 1/05

(52) U.S. Cl. 426/330; 426/576

(57) ABSTRACT

Provided is a soft candy that is sufficiently chewable even if sourness has been removed, and has, for example, excellent compatibility with milk flavors, green tea flavors, and the like. The soft candy, which combines at least saccharides, vegetable oil, an emulsifier, and gelatin, comprises one or more components selected from a group consisting of gluconic acids, gluconates, glucono delta lactones, phytic acids, phosphoric acids, and phosphates, and is made such that the pH is 2.0 to 6.0 in mass conversion when measured by melting in nine times the amount of water. The soft candy exhibits a desirable flavor without losing other flavors, even when added to flavors that are characterized by a quality featuring the masking of sourness, for example: dairy product flavors such as milk, western confectionery flavors such as chocolate, Japanese confectionery flavors such as cotton candy, luxury beverage flavors such as green tea, spice and herb flavors such as cinnamon, fish, meat, egg, and cuisine flavors thereof such as sausage, or plant and cuisine flavors thereof such as potato, chestnut, and vegetables.

### TECHNICAL FIELD

The present invention relates to a soft candy which exhibits no sourness and a production method for the soft candy.

### BACKGROUND ART

A soft candy has a soft chewing texture and melts in the mouth while being chewed. The soft candy has specific chewing property, and hence its texture can be enjoyed until swallowing. Therefore, the candy is popular among wide age ranges. In such soft candy, gelatin is blended to impart the chewing property to the candy, and as the gelatin, there has been generally used acid-treated gelatin extracted from a raw material through an acid treatment or alkali-treated gelatin extracted from a raw material through a lime treatment from the viewpoints of cost, texture, flavor, and the like.

As for the soft candy, Patent Literature 1 below discloses an invention having an object to provide a soft candy which has excellent softness at the beginning of chewing and hardly sticks to the teeth.

### CITATION LIST

### Patent Literature

[PTL 1] JP 3618718 B2

### SUMMARY OF INVENTION

### Technical Problem

A soft candy is flavored with a fruit juice or a perfume, and hence its flavor can be enjoyed as well as its texture. However, many of conventional soft candies have fruit tastes or the like, and all of them have sourness.

On the other hand, the inventors of the present invention have attempted to produce a soft candy having a milk taste, a green tea taste, or the like, but have found that such taste is not compatible with sourness. Therefore, the inventors have tried decreasing the amount of an acidulant to reduce the sourness of the soft candy, and have found that the decrease of the amount of the acidulant results in such a problem that preferred chewing property and chewing texture cannot be obtained because the viscosity of gelatin is lowered through a shift of the pH of the whole of the soft candy to a neutral side.

Therefore, an object of the present invention is to provide a soft candy which has sufficient chewing property even though sourness has been removed and is compatible with, for example, a milk taste or a green tea taste, and a production method for the soft candy.

### Solution to Problem

The inventors of the present invention have found that a soft candy having sufficient chewing property can be obtained by blending gluconic acid, a gluconate, glucono delta lactone, phytic acid, phosphoric acid, and/or a phosphate even if sourness which is not compatible with a milk taste, a green tea taste, and the like is reduced, thus completing the present invention.

That is, a soft candy of the present invention includes at least a saccharide, a vegetable oil and fat, an emulsifier, and gelatin, which further includes one kind or two or more kinds selected from the group consisting of gluconic acid, a gluconate, glucono delta lactone, phytic acid, phosphoric acid, and a phosphate, and has a pH measured when the soft candy is dissolved in a 9-fold amount of water on a mass basis of 2.0 to 6.0.

The soft candy of the present invention contains one kind or two or more kinds selected from the group consisting of gluconic acid, a gluconate, glucono delta lactone, phytic acid, phosphoric acid, and a phosphate, and hence may have a pH measured when the soft candy is dissolved in a 9-fold amount of water on a mass basis of as relatively low as 2.0 to 6.0. Therefore, it is possible to increase the viscosity of gelatin without exhibiting sourness and to provide a soft candy having preferred chewing feeling or chewing texture. Therefore, the present invention is suitable for a soft candy provided with a taste which is not compatible with the sourness, such as a milk taste or a green tea taste.

The soft candy of the present invention preferably includes the one kind or two or more kinds selected from the group consisting of gluconic acid, a gluconate, glucono delta lactone, phytic acid, phosphoric acid, and a phosphate at a total content of 0.001 to 5.0% by mass.

The soft candy of the present invention preferably further includes at least one kind of flavoring material and/or perfume selected from grains, potatoes and starches, sugars and sweeteners, beans, nuts and seeds, vegetables, fruits, mushrooms, algae, sea foods, meats, eggs, milks, oils and fats, confectioneries, preference beverages, seasonings and spices, and cooked and processed food milk raw materials. In this soft candy, one kind or two or more kinds selected from the group consisting of gluconic acid, a gluconate, glucono delta lactone, phytic acid, phosphoric acid, and a phosphate contained in the soft candy are compatible with the flavors of those flavoring materials and/or perfumes.

The soft candy of the present invention, including the flavoring material and/or perfume, preferably has one kind of taste selected from milk product tastes of milk and the like, western confectionery tastes of chocolate and the like, Japanese confectionery tastes of cotton candy and the like, preference beverage tastes of green tea and the like, spice or herb tastes of cinnamon and the like, tastes of sea foods, meats, eggs, or cooked products thereof such as sausage, and tastes of plants or cooked products thereof such as potatoes, chestnuts, and vegetables. In this soft candy, one kind or two or more kinds selected from the group consisting of gluconic acid, a gluconate, glucono delta lactone, phytic acid, phosphoric acid, and a phosphate contained in the soft candy do not impair the flavors.

The soft candy of the present invention preferably has a taste that substantially exhibits no sourness. Here, the phrase “substantially exhibits no sourness” means a taste which is felt to have no sourness by 70% or more of panelists in a sensory test performed by ten or more panelists.

Meanwhile, a production method for a soft candy according to the present invention includes: emulsifying a saccharide, water, a vegetable oil and fat, and an emulsifier by mixing to prepare a soft candy raw material solution; boiling the soft candy raw material solution down to prepare a soft candy base; mixing a gelatin solution with the soft candy base at a predetermined temperature; and cooling the resultant product, the method further including adding one kind or two or more kinds selected from the group consisting of gluconic acid, a gluconate, glucono delta lactone, phytic acid, phosphoric acid, and a phosphate to (1) the soft candy raw material solution, (2) the soft candy base, and/or (3) a product obtained by adding the gelatin solution to the soft candy base in such an amount that a pH measured when the resultant soft candy as a final product is dissolved in a 9-fold amount of water on a mass basis is 2.0 to 6.0.

According to the production method for a soft candy according to the present invention, the viscosity of the gelatin can be increased by maintaining pH to a relatively low value while reducing sourness because in a step in the production of the soft candy, one kind or two or more kinds selected from the group consisting of gluconic acid, a gluconate, glucono delta lactone, phytic acid, phosphoric acid, and a phosphate are added to (1) the soft candy raw material solution, (2) the soft candy base, and/or (3) a product obtained by adding the gelatin solution to the soft candy base in such an amount that a pH measured when the resultant soft candy as a final product is dissolved in a 9-fold amount of water on a mass basis is 2.0 to 6.0. Therefore, it is possible to produce a soft candy which exhibits no sourness and has preferred chewing feeling and chewing texture.

In the production method for a soft candy according to the present invention, the one kind or two or more kinds selected from the group consisting of gluconic acid, a gluconate, glucono delta lactone, phytic acid, phosphoric acid, and a phosphate are preferably added at a total content of 0.001 to 5.0% by mass.

The production method for a soft candy according to the present invention preferably further includes adding at least one kind of flavoring material and/or perfume selected from grains, potatoes and starches, sugars and sweeteners, beans, nuts and seeds, vegetables, fruits, mushrooms, algae, sea foods, meats, eggs, milks, oils and fats, confectioneries, preference beverages, seasonings and spices, and cooked and processed food milk raw materials. With this, there may be provided a soft candy in which one kind or two or more kinds selected from the group consisting of gluconic acid, a gluconate, glucono delta lactone, phytic acid, phosphoric acid, and a phosphate contained in the soft candy are compatible with the flavors of those flavoring materials and/or perfumes.

In the production method for a soft candy according to the present invention, including the adding of the flavoring material and/or perfume, a soft candy is preferably produced so as to have one kind of taste selected from milk product tastes of milk and the like, western confectionery tastes of chocolate and the like, Japanese confectionery tastes of cotton candy and the like, preference beverage tastes of green tea and the like, spice or herb tastes of cinnamon and the like, tastes of sea foods, meats, eggs, or cooked products thereof such as sausage, and tastes of plants or cooked products thereof such as potatoes, chestnuts, and vegetables. With this, one kind or two or more kinds selected from the group consisting of gluconic acid, a gluconate, glucono delta lactone, phytic acid, phosphoric acid, and a phosphate added to the soft candy do not impair the flavors.

### Effects of Invention

According to the present invention, the soft candy includes at least a saccharide, a vegetable oil and fat, an emulsifier, and gelatin, which further includes one kind or two or more kinds selected from the group consisting of gluconic acid, a gluconate, glucono delta lactone, phytic acid, phosphoric acid, and a phosphate, and hence the soft candy may have a pH measured when the candy is dissolved in a 9-fold amount of water on amass basis of as relatively low as 2.0 to 6.0. Therefore, it is possible to increase the viscosity of gelatin without exhibiting sourness and to provide a soft candy having preferred chewing feeling or chewing texture. Therefore, the present invention is suitable for a soft candy provided with a taste which is not compatible with the sourness, such as a milk taste or a green tea taste.

### BRIEF DESCRIPTION OF DRAWING

FIG. 1 is a model diagram illustrating a time-course change in stress of a soft candy to a measurement probe, which is measured with a texture analyzer.

### DESCRIPTION OF EMBODIMENTS

As a saccharide to be used in the present invention, there are given, for example: a monosaccharide such as glucose or fructose; a disaccharide such as sugar, maltose, or lactose; an oligosaccharide or polysaccharide such as starch syrup or maltodextrin; and a sugar alcohol such as sorbitol. One kind or two or more kinds of the saccharides may be used. Of those, starch syrup and sugar are preferred.

The physical properties such as melting point of a vegetable oil and fat to be used in the present invention are not particularly limited, and examples of the vegetable oil and fat include a rapeseed oil and a hardened oil thereof. One kind or two or more kinds of the oils and fats may be used.

An emulsifier to be used in the present invention is not particularly limited as long as it can emulsify the vegetable oil and fat. Examples thereof include food emulsifiers such as a sucrose fatty acid ester, a sorbitan fatty acid ester, a monoglyceride, a diglyceride, and lecithin. One kind or two or more kinds of the emulsifiers may be used. Of those, a sucrose fatty acid ester and a sorbitan fatty acid ester are preferred, and particularly preferably, the two kinds of emulsifiers are used in combination. In addition, the emulsifier to be used may be hydrophilic or lipophilic, and preferably, a hydrophilic emulsifier and a lipophilic emulsifier are used in combination.

A raw material for gelatin to be used in the present invention is not particularly limited, and the gelatin to be used may be derived from, for example, bovine bone, bovine hide, pig hide, fish skin, or fish scale. Of those, pig hide and fish skin are preferred. In order to extract high-quality gelatin efficiently from the raw material, the raw material is subjected to a pretreatment for several hours to several days using an inorganic acid such as hydrochloric acid or sulfuric acid. Alternatively, the raw material is subjected to an alkali treatment such as a lime treatment. In general, alkali-treated gelatin requires a high production cost because it takes several months to treat the gelatin. In the present invention, acid-treated gelatin obtained through a pretreatment with an inorganic acid, which requires a low cost, is preferably used.

As for the grain sizes of the gelatin, the gelatin has preferably 90% by weight or more of 4 mesh-pass particles and 60% by weight or more of 20 mesh-on particles, particularly preferably 95% by weight or more of 4 mesh-pass particles and 80% by weight or more of 20 mesh-on particles from the viewpoints of solubility in water, foaming property, shape stability of a soft candy, and the like. Further, as for the gel strength of the gelatin, the gelatin has a bloom value of preferably 100 to 300, more preferably 150 to 280, particularly preferably 180 to 240 from the viewpoints of the shape stability of a soft candy and the like.

A soft candy of the present invention has blended therein at least the saccharide, vegetable oil and fat, emulsifier, and gelatin described above, and further contains one kind or two or more kinds selected from the group consisting of gluconic acid, a gluconate, glucono delta lactone, phytic acid, phosphoric acid, and a phosphate. In addition, the soft candy has a pH measured when the candy is dissolved in a 9-fold amount of water on a mass basis of 2.0 to 6.0. The pH is more preferably 3.0 to 5.5, most preferably 4.0 to 5.0.

The soft candy contains the one kind or two or more kinds selected from the group consisting of gluconic acid, a gluconate, glucono delta lactone, phytic acid, phosphoric acid, and a phosphate at a total content of preferably 0.001 to 5.0% by mass, more preferably 0.01 to 4.0% by mass, most preferably 0.1 to 3.0% by mass.

Table 1 below shows food additives generally used in Japan as examples of the gluconic acid, gluconate, glucono delta lactone, phytic acid, phosphoric acid, and phosphate used in the present invention. The additives are used, for example, as acidulants for imparting sourness to food and as pH adjusters for adjusting pH, and can be used safely in the present invention as well. However, the additives are not limited thereto. It should be noted that applications of the above-mentioned additives vary among countries, and the additives are shown not only as the acidulants and pH adjusters but also as moisturizers, conditioning agents, acidity adjusters, and the like in other countries than Japan.

TABLE 1

| | Another name/abbreviated |
|---|---|
| Japanese additive name | name/classification name |
| Glucono delta lactone | Glucono lactone |
| Gluconic acid | Gluconic acid solution |
| Potassium gluconate | K gluconate |
| Sodium gluconate | Na gluconate |
| Phytic acid | |
| Phosphoric acid | |
| Dipotassium hydrogen | Dipotassium phosphate, K phosphate, |
| phosphate | potassium phosphate |
| Potassium dihydrogen | Monopotassium phosphate, K phosphate, |
| phosphate | potassium phosphate |
| Disodium hydrogen phosphate | Disodium phosphate, Na phosphate, |
| | sodium phosphate |
| Sodium dihydrogen phosphate | Monosodium phosphate, Na phosphate, |
| | sodium phosphate |

In the soft candy of the present invention, at least one kind of flavoring material and/or perfume selected from grains, potatoes and starches, sugars and sweeteners, beans, nuts and seeds, vegetables, fruits, mushrooms, algae, sea foods, meats, eggs, milks, oils and fats, confectioneries, preference beverages, seasonings and spices, and cooked and processed food milk raw materials may be blended as required. Further, through the incorporation of the flavoring material and/or perfume, the soft candy may have any of milk product tastes of milk and the like, western confectionery tastes of chocolate and the like, Japanese confectionery tastes of cotton candy and the like, preference beverage tastes of green tea and the like, spice or herb tastes of cinnamon and the like, tastes of sea foods, meats, eggs, and cooked products thereof such as sausage, and tastes of plants and cooked products thereof such as potatoes, chestnuts, and vegetables.

The soft candy of the present invention may be provided with preferred chewing property by incorporating the gelatin at a content of preferably about 0.1 to 5% by mass, more preferably about 1.0 to 5% by mass with respect to the whole of the soft candy. An objective evaluation of the chewing property of the soft candy can be performed in accordance with, for example, a method described in Test Example 2 below using a measurement instrument for textures, “texture analyzer TA.XT plus” (manufactured by EIKO Instruments Co., Ltd.). Specifically, the chewing property of the soft candy can be evaluated based on the degree of return, i.e., rebound (swelling return) which enables chewing of the soft candy again after chewing the soft candy once. An index value of the chewing property obtained by the method described in Test Example 2 below reflects the degree objectively. In the soft candy of the present invention, the index value of the chewing property obtained by the method is preferably 4,000 to 4,800 (g), more preferably 4,300 to 4,800 (g) as a mean value determined by measurement for about ten samples.

The specific gravity of the soft candy of the present invention is preferably 1.3 or less, particularly preferably 1.25 or less from the viewpoints of lightness of texture, softness at the beginning of chewing, and difficulty of sticking to teeth. Further, the water content of the soft candy of the present invention is preferably 5 to 10% by weight, particularly preferably 6 to 9% by weight from the viewpoints of prevention of sticking to the teeth and shape stability.

The soft candy of the present invention has a higher commercial value because the candy has a taste of characteristic quality that desirably exhibits no sourness.

Meanwhile, a production method for a soft candy according to the present invention includes: emulsifying a saccharide, water, a vegetable oil and fat, and an emulsifier by mixing to prepare a soft candy raw material solution; boiling the soft candy raw material solution down to prepare a soft candy base; mixing a gelatin solution with the resultant soft candy base at a predetermined temperature; and cooling the resultant product to obtain a soft candy.

(Preparation of Soft Candy Raw Material Solution and Soft Candy Base)

The soft candy raw material solution is prepared by emulsifying a saccharide, water, a vegetable oil and fat, and an emulsifier by mixing. Mixing of the raw materials may be performed using, for example, a super mixer. After mixing, the mixture is heated to preferably 70 to 90° C. and emulsified using, for example, the super mixer.

Next, the resultant soft candy raw material solution is boiled down to prepare a soft candy base. In this procedure, the solution is preferably boiled down under reduced pressure so as not to be colored. In addition, the water content of the soft candy base after boiling down is preferably 1 to 10% by weight, more preferably 2 to 7% by weight, particularly preferably 3 to 6% by weight.

(Preparation of Fondant)

In the production method for a soft candy according to the present invention, a sugar fine crystal with a size of less than 30 μm, preferably 5 to 20 μm (hereinafter, referred to as “fondant”) may be prepared and blended. For example, the fondant may be prepared as follows.

That is, sugar, a saccharide other than sugar, such as starch syrup, and water are mixed with each other, and the mixture is boiled down at preferably 100 to 140° C., particularly preferably 110 to 130° C. until the water content reaches preferably 20% by weight or less, particularly preferably 5 to 15% by weight. Subsequently, the resultant may be cooled, stirred, and mixed to prepare a fondant. Here, as the saccharide other than sugar, starch syrup is preferred. A ratio (weight ratio) between sugar and the saccharide other than sugar is preferably 50:50 to 95:5, more preferably 60:40 to 90:10, particularly preferably 70:30 to 85:15. The water content of the fondant is preferably 5 to 15% by weight, more preferably 6 to 14% by weight, particularly preferably 8 to 12% by weight. When such fondant is used, a soft candy which is soft at the beginning of chewing, hardly sticks to the teeth, and has shape stability can be obtained.

(Mixing of Soft Candy Base and Fondant)

In the production method for a soft candy according to the present invention, in the case where the fondant is blended, a mixture of the soft candy base and the fondant is preferably prepared according to the following mode.

That is, the mixing ratio (weight ratio) between the soft candy base and the fondant is preferably 99:1 to 70:30, more preferably 95:5 to 75:25, particularly preferably 90:10 to 80:20. The mixing temperature is preferably maintained to 50 to 70° C. to prevent melting of the fondant. In this procedure, sugar in the soft candy base is preferably crystallized. Sugar can be crystallized by kneading the soft candy base and the fondant at 50 to 70° C. for 30 seconds or more.

(Preparation of Frappe)

In the production method for a soft candy according to the present invention, a gelatin-containing product prepared by whipping a solution containing gelatin (hereinafter, referred to as “frappe”) may be prepared and blended. For example, the frappe can be prepared as follows.

That is, a saccharide such as sugar or starch syrup and water are mixed with each other, and the mixture is boiled down at preferably 80 to 130° C., particularly preferably 90 to 120° C. so that a sugar degree reaches preferably Bx70 to 95°, particularly preferably Bx75 to 90°, and then cooled to preferably 60 to 90° C., particularly preferably 65 to 80° C. Separately, gelatin and water are mixed with each other, and the gelatin is dissolved by heating preferably at 60 to 90° C., followed by mixing with the above-mentioned cooled saccharide solution. The mixture is whipped so that a specific gravity is preferably 0.3 to 0.5, particularly preferably 0.35 to 0.45, to thereby prepare the frappe. In this procedure, preferably, the gelatin is swollen in water whose weight is preferably 0.5 to 4 times, particularly preferably 1 to 3 times the weight of the gelatin, and dissolved by heating. The frappe has a composition (weight ratio) “sugar:starch syrup:gelatin:water” of preferably 20 to 50:20 to 50:1 to 10:10 to 30, particularly preferably 25 to 45:25 to 45:2 to 8:15 to 25. When such frappe is blended, a soft candy which has light texture, is soft at the beginning of chewing, and hardly sticks to the teeth can be obtained.

(Mixing of Gelatin Solution)

In the production method for a soft candy according to the present invention, the soft candy base and the gelatin solution are mixed with each other at a predetermined temperature. Mixing is preferably performed using the frappe which is a gelatin-containing product according to the following mode.

That is, from the viewpoint of reducing disintegration of an aerated gel as much as possible, the frappe is added to the soft candy base or the mixture of the soft candy base and the fondant preferably within 2 hours, particularly preferably within 1.5 hours of the preparation of the frappe. In this procedure, as described above, if the product temperature during mixing and/or after mixing exceeds 70° C., the fondant may be melted, or the gel strength of the gelatin may decrease. Therefore, the product temperature is preferably maintained at 50 to 70° C. The mixture is kneaded for 30 seconds or more at the above-mentioned temperature. When the mixture is kneaded for 30 seconds or more, effects of crystallization of the fondant and dispersion of the fondant into the soft candy base are improved.

It should be noted that, from the viewpoint of imparting preferred chewing property to the soft candy, the gelatin is preferably mixed in the whole of the soft candy at a content of preferably about 0.1 to 5% by mass, more preferably about 1.0 to 5% by mass. Further, from the viewpoint of lightness of texture, the gelatin is mixed so that the specific gravity is preferably less than 1.3, particularly preferably less than 1.25.

The order of mixing of the soft candy base, the fondant, and the frappe is not limited to the above-mentioned one. That is, the fondant may be added and mixed after mixing the soft candy base and the frappe, or the soft candy base, the fondant, and the frappe may be simultaneously added and mixed. It should be noted that, as described above, the product temperature is preferably maintained at 50 to 70° C. because when the product temperature during mixing and/or after mixing exceeds 70° C., the fondant may be melted, or the gel strength of the gelatin may decrease.

In the production method for a soft candy according to the present invention, one kind or two or more kinds selected from the group consisting of gluconic acid, a gluconate, glucono delta lactone, phytic acid, phosphoric acid, and a phosphate are added to (1) the soft candy raw material solution, (2) the soft candy base, and/or (3) a product obtained by adding the gelatin solution to the soft candy base in such an amount that a pH measured when the resultant soft candy as a final product is dissolved in a 9-fold amount of water on a mass basis is 2.0 to 6.0. The pH is more preferably 3.0 to 5.5, most preferably 4.0 to 5.0.

In the production method for a soft candy according to the present invention, the one kind or two or more kinds selected from the group consisting of gluconic acid, a gluconate, glucono delta lactone, phytic acid, phosphoric acid, and a phosphate are added at a total content of preferably 0.001 to 5.0% by mass, more preferably 0.01 to 4.0% by mass, most preferably 0.1 to 3.0% by mass.

In the production method for a soft candy according to the present invention, at least one kind of flavoring material and/or perfume selected from grains, potatoes and starches, sugars and sweeteners, beans, nuts and seeds, vegetables, fruits, mushrooms, algae, sea foods, meats, eggs, milks, oils and fats, confectioneries, preference beverages, seasonings and spices, and cooked and processed food milk raw materials may be added as required. Further, through the addition of the flavoring material and/or perfume, a soft candy may be produced so as to have any of milk product tastes of milk and the like, western confectionery tastes of chocolate and the like, Japanese confectionery tastes of cotton candy and the like, preference beverage tastes of green tea and the like, spice or herb tastes of cinnamon and the like, tastes of sea foods, meats, eggs, and cooked products thereof such as sausage, and tastes of plants and cooked products thereof such as potatoes, chestnuts, and vegetables.

A soft candy can be produced as described above, but a soft candy having a higher commercial value can be produced by forming the candy into a predetermined size and shape or by reducing deformation of the resultant formed product, as required. In addition, soft candies having different colors or flavors may be produced, and a multilayer candy may be produced from the candies. Further, one soft candy may be covered with another soft candy having a color or flavor different from that of the former soft candy.

The soft candy obtained by the production method of the present invention may have a higher commercial value because the candy has a taste of characteristic quality that desirably exhibits no sourness.

### EXAMPLES

Hereinafter, the present invention is described specifically by way of examples, but the scope of the present invention is not limited by the examples.

### Production Example 1

Soft candies were produced in the same manner as in the method described in JP 3618718 B2. In this process, acids shown in Table 2 below were used as acidulants. That is, gluconic acid (Example 1), citric acid (Example 2), malic acid (Example 3), or lactic acid (Example 4) was added so that soft candies obtained using the respective acids have the same pH (pH 4.5) by adjusting the amounts of the acids blended. It should be noted that the pH of each soft candy is a pH measured when the candy was dissolved in a 9-fold amount of water on a mass basis.

TABLE 2

| | | pH of resultant soft candy |
|---|---|---|
| | | (measured by dissolving the |
| | Kind of acid blended | candy in 9-fold amount of water) |
| Example 1 | Gluconic acid | 4.5 |
| Example 2 | Citric acid | 4.5 |
| Example 3 | Malic acid | 4.5 |
| Example 4 | Lactic acid | 4.5 |

The production method is as follows.

(1) Preparation of Soft Candy Raw Material Solution

Sugar (50 parts by weight), starch syrup (50 parts by weight), water (10 parts by weight), a sorbitan fatty acid ester (0.15 part by weight), and a sucrose fatty acid ester having an HLB of 11 (0.15 part by weight) were mixed with each other in a super mixer, and the mixture was heated to 80° C. with stirring. Subsequently, a rapeseed oil (10 parts by weight) was mixed therein, and the mixture was emulsified with stirring, to thereby obtain a soft candy raw material solution.

(2) Preparation of Soft Candy Base

The soft candy raw material solution obtained in (1) was boiled down using a super film cooker (manufactured by SAKUMA CO., LTD.) at a vacuum of 600 mmHg and a temperature of 118° C. until the water content reached about 5% by weight, and the resultant was cooled to 70° C., to thereby obtain a soft candy base.

(3) Preparation of Fondant

Sugar (70 parts by weight), starch syrup (30 parts by weight), and water (20 parts by weight) were mixed with each other in a melting tank, and the mixture was boiled down at 121° C. until the water content reached 10% by weight. Subsequently, the resultant was cooled to 70° C., to thereby obtain a fondant having a particle size of 30 μm or less.

(4) Preparation of Frappe

Sugar (75 parts by weight), starch syrup (75 parts by weight), and water (25 parts by weight) were mixed with each other, and the mixture was boiled down at 118° C. until the sugar degree reached Bx90°, and then cooled to 70° C. Separately, acid-treated gelatin (gel strength: 200 bloom, grain size: 4 mesh-pass 100%, 20 mesh-on 90%) (10 parts by weight) was dissolved in a 2-fold amount of water at 80° C., and the solution was defoamed and then cooled to 70° C. (gelatin solution). Subsequently, both were mixed with each other at 8:1 (weight ratio), to thereby obtain a frappe. The sugar degree of the frappe was found to be Bx80°.

(5) Mixing of Soft Candy Base, Fondant, Frappe, and the Like

The soft candy base (80 parts by weight), the fondant (20 parts by weight), and the gelatin solution prepared in (4) (1 part by weight) were mixed with each other, and the mixture was kneaded for 30 seconds or more. The temperature after kneading was found to be 70° C. Subsequently, any one of the acids shown in Table 2 above, a fruit juice, a perfume, and a colorant were added thereto, and the frappe was further added, followed by stirring for 30 seconds or more. The temperature after stirring was found to be 65° C. Next, the resultant was cooled to 45° C., to thereby obtain a soft candy composition.

(6) Forming of Soft Candy

The soft candy composition obtained above was formed, and the resultant was rolled over to reduce deformation, to thereby obtain a soft candy.

### Test Example 1

A sensory evaluation was performed by giving the respective soft candies of Examples 1 to 4 produced in Production Example 1 to eleven specialist panelists. That is, the order of the soft candies was decided based on unsourness by a ranking method as follows: a soft candy which was evaluated to be the least sour was evaluated as “1”, and a soft candy which was evaluated to be the second least sour was evaluated as “2”. It should be notes that, if two soft candies were evaluated to rank second at the equal value, the candies were evaluated as “2.5”, and if two soft candies were evaluated to rank third at the equal value, the candies were evaluated as “3.5”. In addition, the panelists answered a question whether there was a soft candy having no chewing property (unsatisfactory soft candy) among the soft candies. Table 3 below shows the results.

TABLE 3

| | Example 1 | Example 2 | Example 3 | Example 4 | |
|---|---|---|---|---|---|
| | Gluconic | Citric | Malic | Lactic | Asked whether there is a soft candy having no |
| Blended acidulant | acid | acid | acid | acid | chewing property (unsatisfactory soft candy) |
| | Order of sourness | | | | |
| Panelist 1 | 1 | 2.5 | 4 | 2.5 | No soft candy having no chewing property |
| Panelist 2 | 1 | 3 | 4 | 2 | No soft candy having no chewing property |
| Panelist 3 | 1 | 2.5 | 4 | 2.5 | No soft candy having no chewing property |
| Panelist 4 | 1 | 3.5 | 3.5 | 2 | No soft candy having no chewing property |
| Panelist 5 | 1 | 4 | 3 | 2 | No soft candy having no chewing property |
| Panelist 6 | 1 | 3 | 4 | 2 | No soft candy having no chewing property |
| Panelist 7 | 2 | 1 | 3.5 | 3.5 | No soft candy having no chewing property |
| Panelist 8 | 1 | 4 | 2.5 | 2.5 | No soft candy having no chewing property |
| Panelist 9 | 1 | 2 | 4 | 3 | No soft candy having no chewing property |
| Panelist 10 | 1 | 2 | 4 | 3 | No soft candy having no chewing property |
| Panelist 11 | 1 | 2 | 3 | 4 | No soft candy having no chewing property |
| Mean of order of | 1.09 | 2.68 | 3.59 | 2.64 | |
| sourness | | | | | |

As a result, the soft candy having blended therein gluconic acid was evaluated to have the least sourness by ten panelists, and the other one panelist evaluated the candy to be the second least sour. In addition, all the eleven panelists answered that there were no soft candies having no chewing property (unsatisfactory soft candies) among the soft candies.

Therefore, the soft candy having blended therein gluconic acid was found to have less sourness compared with the soft candies having blended therein citric acid, malic acid, and lactic acid, and to have good chewing property.

### Test Example 2

A soft candy having blended therein citric acid (Example 5), a soft candy having blended therein gluconic acid (Example 6), and a soft candy produced without blending any of the acids (Example 7) were produced in the same manner as in Production Example 1, and for 10 samples of each of the soft candies, the chewing property was measured by the following method.

(Measurement Method)

Measurement instrument: a texture analyzer TA.XT plus manufactured by EIKO Instruments Co., Ltd.

Name of measurement probe: 10 mm DIA CYLINDER EBONITE

(1) The soft candies were formed into rectangular solids each having a weight of about 5.0 g and a size of about 25 mm long, 14 mm wide, and 11 mm high. A surface with a size of 25 mm×14 mm was used as a measurement surface.
(2) Each of the soft candies was fixed on a sample stage of the texture analyzer. In order to keep the product temperature of the soft candy at 20°, measurement was performed in a room controlled to 20°.
(3) A measurement probe (having a cylindrical shape with a diameter of 10 mm) of the analyzer was pulled down at a speed of 1 mm/sec to insert the probe into the surface of the soft candy, and a stress (force) was measured in a range of the maximum load of 25 kg.
(4) The measurement probe was lifted at a speed of 1 mm/sec when the probe was inserted by 5 mm from the surface of the soft candy.
(5) After the measurement probe departed from the soft candy, the measurement probe was pulled down again (second time) at a speed of 1 mm/sec and inserted into the surface of the soft candy, and the probe was lifted again at a speed of 1 mm/sec when the probe was inserted by 5 mm from the surface.

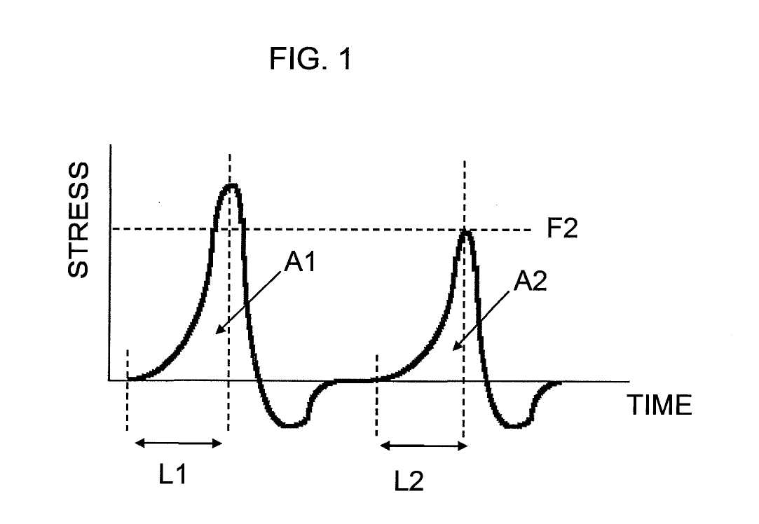

FIG. 1 is a model diagram illustrating a time-course change of the stress of the soft candy to the measurement probe generated by the above-mentioned process. From an actual measurement graph, values corresponding to an area under a first stress peak curve (A1), an area under a second stress peak curve (A2), a second maximum stress (F2) (actual measurement unit g), a time between the initial rise of the first stress peak curve and the top of the peak (L1), and a time between the initial rise of the second stress peak curve and the top of the peak (L2) shown in FIG. 1 can be determined. The values were applied into a calculation formula represented by the following equation (1), and the resultant value was designated as an index value of the chewing property of the soft candy (Ch).

[Math. 1]

Ch=(L2/L1)×{F2×(A2/A1)} (1)

It should be noted that the chewing property of the soft candy can be evaluated by the degree of return, i.e., rebound (swelling return) which enables chewing of the soft candy again after chewing the soft candy once. The above-mentioned index value reflects the degree objectively. That is, the soft candy dents once when the soft candy is pressed by the probe for the first time, but the candy rebounds back as the probe is pulled up. After that, the soft candy is pressed again by the probe for the second time, and a force required to denting the candy by the same distance as that of the first time (F2) is measured. The index value can be determined from the F2, a ratio between the L1 and L2, and a ratio between the A1 and A2. The index value is closely associated with the chewing property of the soft candy.

Table 4 below shows the results.

TABLE 4

| Blended | Example 5 | Example 6 | Example 7 |
|---|---|---|---|
| acidulant | Citric acid | Gluconic acid | None |
| | Index value of chewing property (Ch) | | |
| Sample 1 | 5,067.01 | 5,148.51 | 3,127.74 |
| Sample 2 | 4,263.40 | 4,302.63 | 3,417.65 |
| Sample 3 | 4,816.94 | 4,902.51 | 4,149.55 |
| Sample 4 | 5,129.37 | 4,672.33 | 3,658.72 |
| Sample 5 | 4,539.51 | 4,262.13 | 3,384.68 |
| Sample 6 | 4,334.26 | 5,078.56 | 3,390.04 |
| Sample 7 | 4,887.50 | 4,823.99 | 3,816.26 |
| Sample 8 | 4,774.10 | 4,513.92 | 3,822.77 |
| Sample 9 | 4,298.38 | 4,464.00 | 4,369.36 |
| Sample 10 | 3,957.99 | 3,776.68 | 3,476.97 |
| Mean | 4,606.85 | 4,594.53 | 3,661.37 |

The results show that there is no significant difference in the index values of the chewing property between the soft candy including gluconic acid and the soft candy including citric acid, and the index values of the chewing property determined by the above-mentioned measurement method are well matched with the results of the sensory evaluation of the chewing property by eleven specialist panelists (Test Example 1). On the other hand, in the case of the soft candy having added thereto none of the citric acid and the gluconic acid, the index values of the chewing property are low, and it was found that the chewing property unique to soft candies was impaired.

### Production Example 2

A soft candy having blended therein gluconic acid (Example 8), a soft candy produced without blending any of the acids (Example 9), and a soft candy having blended therein citric acid (Example 10) were produced in the same manner as in Production Example 1 except that alkali-treated gelatin (gel strength: 250 bloom, grain size: 4 mesh-pass 100%, 20 mesh-on 90%) was used as gelatin.

### Test Example 3

A sensory evaluation was performed for each of sourness and chewing property by giving the respective soft candies of Examples 8 to 10 produced in Production Example 2 to eleven specialist panelists. Tables 5 and 6 below show the results.

TABLE 5

| | | |
|---|---|---|
| | Question: | |
| | Is the | |
| | candy is | |
| Blended | sour? | Total |

| | acidulant | Yes | No | (panelists) |
|---|---|---|---|---|
| Example 8 | Gluconic acid | 1 | 10 | 11 |
| Example 9 | None | 1 | 10 | 11 |
| Example 10 | Citric acid | 9 | 2 | 11 |

TABLE 6

| | | |
|---|---|---|
| | Question: | |
| | Does the | |
| | candy | |
| | have | |
| | chewing | |
| Blended | property? | Total |

| | acidulant | Yes | No | (panelists) |
|---|---|---|---|---|
| Example 8 | Gluconic acid | 11 | 0 | 11 |
| Example 9 | None | 2 | 9 | 11 |
| Example 10 | Citric acid | 7 | 4 | 11 |

As a result, in the case of the soft candy of Example 8 produced using gluconic acid, ten of the eleven panelists evaluated the candy to be “not sour”, while in the case of the soft candy of Example 10 produced using citric acid, nine of the eleven panelists evaluated the candy to be “sour”. Meanwhile, as for the chewing property, in the case of the soft candy of Example 8 produced using gluconic acid, all the eleven panelists evaluated the candy to “have chewing property”, while in the case of the soft candy of Example 9 produced without using any of the citric acid and the gluconic acid, nine of the eleven panelists evaluated the candy to “have no chewing property”.

Therefore, it was found that the soft candy having blended therein citric acid exhibited sourness, while the soft candy having blended therein gluconic acid exhibited no sourness. It was also found that the soft candy having added thereto no acid had chewing property unique to soft candies impaired, while the soft candy having blended therein gluconic acid had good chewing property as well.

1. A soft candy, comprising at least a saccharide, a vegetable oil and fat, an emulsifier, and gelatin, which further comprises one kind or two or more kinds selected from the group consisting of gluconic acid, a gluconate, glucono delta lactone, phytic acid, phosphoric acid, and a phosphate, and has a pH measured when the soft candy is dissolved in a 9-fold amount of water on a mass basis of 2.0 to 6.0.

2. A soft candy according to claim 1, comprising the one kind or two or more kinds selected from the group consisting of gluconic acid, a gluconate, glucono delta lactone, phytic acid, phosphoric acid, and a phosphate at a total content of 0.001 to 5.0% by mass.

3. A soft candy according to claim 1, further comprising at least one kind of flavoring material and/or perfume selected from grains, potatoes and starches, sugars and sweeteners, beans, nuts and seeds, vegetables, fruits, mushrooms, algae, sea foods, meats, eggs, milks, oils and fats, confectioneries, preference beverages, seasonings and spices, and cooked and processed food milk raw materials.

4. A soft candy according to claim 3, comprising the flavoring material and/or perfume, which has one kind of taste selected from milk product tastes, western confectionery tastes, Japanese confectionery tastes, preference beverage tastes, spice or herb tastes, tastes of sea foods, meats, eggs, or cooked products thereof, and tastes of plants or cooked products thereof.

5. A soft candy according to claim 1, which substantially exhibits no sourness.

6. A production method for a soft candy, comprising: emulsifying a saccharide, water, a vegetable oil and fat, and an emulsifier by mixing to prepare a soft candy raw material solution; boiling the soft candy raw material solution down to prepare a soft candy base; mixing a gelatin solution with the soft candy base at a predetermined temperature; and cooling the resultant product, the method further comprising adding one kind or two or more kinds selected from the group consisting of gluconic acid, a gluconate, glucono delta lactone, phytic acid, phosphoric acid, and a phosphate to (1) the soft candy raw material solution, (2) the soft candy base, and/or (3) a product obtained by adding the gelatin solution to the soft candy base in such an amount that a pH measured when the resultant soft candy as a final product is dissolved in a 9-fold amount of water on a mass basis is 2.0 to 6.0.

7. A production method for a soft candy according to claim 6, the one kind or two or more kinds selected from the group consisting of gluconic acid, a gluconate, glucono delta lactone, phytic acid, phosphoric acid, and a phosphate are added at a total content of 0.001 to 5.0% by mass.

8. A production method for a soft candy according to claim 6, further comprising adding at least one kind of flavoring material and/or perfume selected from grains, potatoes and starches, sugars and sweeteners, beans, nuts and seeds, vegetables, fruits, mushrooms, algae, sea foods, meats, eggs, milks, oils and fats, confectioneries, preference beverages, seasonings and spices, and cooked and processed food milk raw materials.

9. A production method for a soft candy according to claim 8, comprising the adding of the flavoring material and/or perfume, wherein the soft candy is produced so as to have one kind of taste selected from milk product tastes, western confectionery tastes, Japanese confectionery tastes, preference beverage tastes, spice or herb tastes, tastes of sea foods, meats, eggs, or cooked products thereof, and tastes of plants or cooked products thereof.
